(19) United States
(12) Patent Application Publication
(10) Pub. No.: US 2023/0262008 A1
(43) Pub. Date: Aug. 17, 2023

(54) METHODS AND SYSTEMS FOR TRANSMITTING DATA OVER A WIRELESS NETWORK

(71) Applicant: TGOMA NZ LIMITED, Christchurch (NZ)

(72) Inventor: John Robert Howe, Christchurch (NZ)

(21) Appl. No.: 18/041,246

(22) PCT Filed: Jun. 30, 2021
(86) PCT No.: PCT/IB2021/055836

§ 371 Date: Feb. 10, 2023

Related U.S. Application Data
(60) Provisional application No. 63/064,481, filed on Aug. 12, 2020.

(51) Int. Cl. H04L 49/90; H04L 49/9047

(52) U.S. Cl. CPC H04L 49/9089; H04L 49/9047; H04W 4/80

(57) ABSTRACT

An aspect of the invention provides a method of transmitting data over a wireless network. The method includes maintaining a plurality of data packets within a first buffer and encoding at least some of the data packets within the first buffer inside a first broadcast packet. A broadcasting device transmits the first broadcast packet over the wireless network. The method further includes maintaining a plurality of data packets within a second buffer and encoding at least some of the data packets within the second buffer inside a second broadcast packet. The broadcasting device transmits the second broadcast packet over the wireless network. The method further includes, on detecting overflow of the first buffer, removing a data packet from the first buffer and adding the removed data packet to the second buffer.

### FIELD OF THE INVENTION

The invention relates to methods and systems for transmitting data over a wireless network. The invention is particularly suited for use in transmitting data from Bluetooth Low Energy (BLE) beacons to a computing device over a bluetooth network.

### BACKGROUND TO THE INVENTION

Trampoline bounce activity includes bounce events such as impact bounce events and depart bounce events. Sensors attached to a trampoline bed of a trampoline detect the bounce activity in the form of impact and depart event timestamps. These timestamps are used to measure various aspects of bounce activity such as time of flight.

One example of a sensor includes a Bluetooth Low Energy (BLE) beacon configured to communicate bounce data from the sensor to a computing device for further processing. Impact bounce events and depart bounce events are encoded within an advertising packet that is then broadcast by the BLE beacon.

The bounce data is required to fit within a single advertising packet. A plurality of data packets representing the bounce data is maintained in a buffer within the beacon. The advertising packet includes the plurality of data packets in the buffer. The buffer functions as a data array. Older data packets are dropped from the data array as new data packets are added that would otherwise overflow the buffer.

There is a limit to the number of bytes of data that can be stored in a buffer in a beacon. As newer bounce events occur, they cause the oldest data packets to be dropped from the beacon and therefore from an advertising packet broadcast by the beacon. As the beacon is a one-way one-to-many communications channel, the data can be received by any number of devices. However, there is no way for the sensor to know whether the bounce event has been received by the correct device or not. Once the data has been dropped from the advertising packet then it is lost forever.

In some environments there are hundreds of Bluetooth devices each broadcasting advertisement packets. The computing device to which the bounce events are broadcast is also receiving advertising packets from other Bluetooth devices. The computing device is required to receive all advertising packets to determine whether or not the advertising packets contain the expected bounce events.

There is a risk that the time taken for the computing device to process all advertising packets may exceed the duration for which a bounce event is broadcast. This has the potential to lead to bounce events being lost.

It is an object of at least preferred embodiments of the present invention to address at least some of the aforementioned disadvantages. An additional or alternative object is to at least provide the public with a useful choice.

### SUMMARY OF THE INVENTION

In accordance with an aspect, a method of transmitting data over a wireless network comprises maintaining a plurality of data packets within a first buffer; encoding at least some of the data packets within the first buffer inside a first broadcast packet; a broadcasting device transmitting the first broadcast packet over the wireless network; maintaining a plurality of data packets within a second buffer; encoding at least some of the data packets within the second buffer inside a second broadcast packet; the broadcasting device transmitting the second broadcast packet over the wireless network; and, on detecting overflow of the first buffer, removing a data packet from the first buffer and adding the removed data packet to the second buffer.

The term ‘comprising’ as used in this specification means ‘consisting at least in part of’. When interpreting each statement in this specification that includes the term ‘comprising’, features other than that or those prefaced by the term may also be present. Related terms such as ‘comprise’ and ‘comprises’ are to be interpreted in the same manner.

In an embodiment the broadcasting device comprises a Bluetooth beacon. In an embodiment the broadcasting device comprises a Bluetooth Low Energy (BLE) beacon.

In an embodiment the wireless network comprises a Bluetooth network.

In an embodiment the method further comprises encoding, within a data packet, a bounce event detected on a trampoline by a sensor; and adding the data packet to the first buffer. In an embodiment the bounce event comprises an impact bounce event or a depart bounce event.

In an embodiment the method comprises maintaining the plurality of data packets within the first buffer as a First In First Out (FIFO) queue.

In an embodiment the method comprises associating the data packets in the first buffer with respective sequence numbers; and, on detecting overflow of the first buffer, selecting for removal a data packet based at least partly on the sequence number associated to the data packet. In an embodiment the method comprises selecting for removal a data packet having the lowest sequence number when compared with other data packets maintained within the first buffer.

In an embodiment the method comprises encoding each of the data packets within the first buffer inside the first broadcast packet. In an embodiment the method comprises encoding each of the data packets within the second buffer inside the second broadcast packet.

In an embodiment the method comprises the broadcasting device transmitting the first broadcast packet over the wireless network to a computing device.

In accordance with an aspect, a data transmission system comprises: a first buffer having stored therein a plurality of data packets; a second buffer having stored therein a plurality of data packets; a buffer manager configured to, on detecting overflow of the first buffer, remove a data packet from the first buffer and add the removed data packet to the second buffer; and a broadcasting device configured to: transmit at least some of the data packets within the first buffer as a first broadcast packet over the wireless network, and transmit at least some of the data packets within the second buffer as a second broadcast packet over the wireless network.

In an embodiment the broadcasting device comprises a Bluetooth beacon. In an embodiment the broadcasting device comprises a Bluetooth Low Energy (BLE) beacon.

In an embodiment the wireless network comprises a Bluetooth network.

In an embodiment the buffer manager is configured to maintain the plurality of data packets within the first buffer as a First In First Out (FIFO) queue.

In an embodiment the data packets in the first buffer are associated with respective sequence numbers; and, on detecting overflow of the first buffer, the buffer manager is configured to select for removal a data packet based at least partly on the sequence number associated to the data packet. In an embodiment the buffer manager is configured to select for removal a data packet having the lowest sequence number when compared with other data packets maintained within the first buffer.

In an embodiment the first broadcast packet includes each of the data packets within the first buffer. In an embodiment the second broadcast packet includes each of the data packets within the second buffer.

In accordance with an aspect, a computer-readable medium has stored thereon computer-executable instructions that, when executed by at least one processor, cause the at least one processor to perform a method of transmitting data over a wireless network. The method comprises maintaining a plurality of data packets within a first buffer; encoding at least some of the data packets within the first buffer inside a first broadcast packet; transmitting the first broadcast packet over the wireless network; maintaining a plurality of data packets within a second buffer; encoding at least some of the data packets within the second buffer inside a second broadcast packet; transmitting the second broadcast packet over the wireless network; and, on detecting overflow of the first buffer, removing a data packet from the first buffer and adding the removed data packet to the second buffer.

In an embodiment the wireless network comprises a Bluetooth network.

In an embodiment the computer-executable instructions cause the at least one processor to detect a bounce event on a trampoline; encode the bounce event within a data packet; and add the data packet to the first buffer. In an embodiment the bounce event comprises an impact bounce event or a depart bounce event.

In an embodiment the computer-executable instructions cause the at least one processor to maintain the plurality of data packets within the first buffer as a First In First Out (FIFO) queue.

In an embodiment the computer-executable instructions cause the at least one processor to associate the data packets in the first buffer with respective sequence numbers; and, on detecting overflow of the first buffer, select for removal a data packet based at least partly on the sequence number associated to the data packet. In an embodiment the computer-executable instructions cause the at least one processor to select for removal a data packet having the lowest sequence number when compared with other data packets maintained within the first buffer.

In an embodiment the computer-executable instructions cause the at least one processor to encode each of the data packets within the first buffer inside the first broadcast packet. In an embodiment the computer-executable instructions cause the at least one processor to encode each of the data packets within the second buffer inside the second broadcast packet.

The invention in one aspect comprises several steps. The relation of one or more of such steps with respect to each of the others, the apparatus embodying features of construction, and combinations of elements and arrangement of parts that are adapted to affect such steps, are all exemplified in the following detailed disclosure.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein, ‘(s)’ following a noun means the plural and/or singular forms of the noun.

As used herein, the term ‘and/or’ means ‘and’ or ‘or’ or both.

As used herein, the term ‘connected to’ in relation to data or signal transfer includes all direct or indirect types of communication, including wired and wireless, via a cellular network, via a data bus, or any other computer structure. It is envisaged that they may be intervening elements between the connected integers. Variants such as ‘in communication with’, ‘joined to’, and ‘attached to’ are to be interpreted in a similar manner. Related terms such as ‘connecting’ and ‘in connection with’ are to be interpreted in the same manner.

As used herein, the terms ‘component’, ‘module’, ‘system’, ‘interface’, and/or the like in relation to a processor are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As used herein, the term ‘computer-readable medium’ should be taken to include a single medium or multiple media. Examples of multiple media include a centralised or distributed database and/or associated caches. These multiple media store the one or more sets of computer executable instructions. The term ‘computer readable medium’ should also be taken to include any medium that is capable of storing, encoding or carrying a set of instructions for execution by a processor and that cause the processor to perform any one or more of the methods described above. The computer-readable medium is also capable of storing, encoding or carrying data structures used by or associated with these sets of instructions. The term ‘computer-readable medium’ includes solid-state memories, optical media and magnetic media.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

Preferred forms of the methods and systems for transmitting data over a wireless network will now be described by way of example only with reference to the accompanying figures in which:

FIG. 1 is an overview of the environment in which data transmitting is required;

FIG. 2 shows an example of a data packet encoding a bounce event;

FIG. 3 shows an example of a data array for storing data packets such as the data packet shown in FIG. 2;

FIG. 4 is an example of a sensor from FIG. 1; and

FIG. 5 is an example of a processor from FIG. 1.

### DETAILED DESCRIPTION

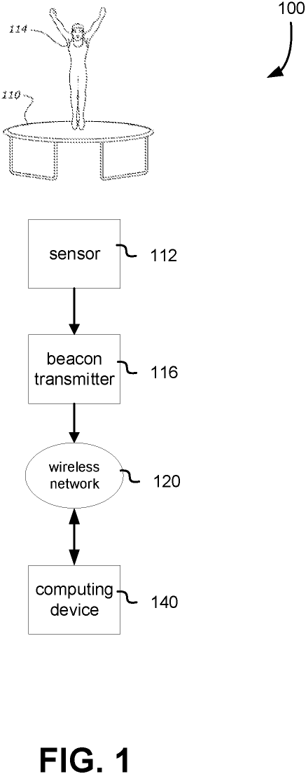

FIG. 1 shows a system 100 in which data transmission over a wireless network is required. A trampoline 110 has an attached sensor 112. In an embodiment the sensor 112 is attached to the side of a trampoline mat. The sensor 112 is configured to detect bounce activity.

An athlete 114 impacting the trampoline mat causes an impact event. The sensor 112 detects the impact event. The sensor 112 checks an internal clock associated to the sensor 112. The sensor 112 then generates an impact event timestamp based on its internal clock.

Similarly, the athlete departing the trampoline mat causes a depart event. The sensor 112 detects the depart event and checks its internal clock to generate a depart event timestamp.

The impact event timestamps and depart event timestamps are transmitted to a broadcasting device such as a beacon transmitter 116. In an embodiment, beacon transmitter 116 comprises a Bluetooth Low Energy (BLE) beacon.

Beacon 116 encodes the impact event timestamps and depart event timestamps within Bluetooth advertisement packets to be broadcast over a wireless network 120 to other devices and components attached to the wireless network 120. In an embodiment, wireless network 120 comprises a Bluetooth network.

A computing device 140 is connected to the wireless network 120. The computing device 140 receives the impact event timestamps and depart event timestamps from the sensor 112. Examples of processors include mobile phones, tablets, laptops and desktop computers.

In an embodiment the computing device 140 calculates time-of-flight for athlete 114 based at least partly on differences between impact event timestamps and depart event timestamps. For example, the time-of-flight for athlete 114 can be calculated from the respective differences between consecutive depart event timestamps and impact event timestamps received from sensor 112.

In an embodiment the beacon transmitter 116 (see FIG. 1) communicates data between the sensor 112 and the computing device 140. The data may then be input to software modules or an app executing on computing device 140.

Beacon transmitter 116 is a one-way transmitter to a receiving device. In practice there will be multiple receiving devices connected to the wireless network 120. Computing device is one such receiving device, or is connected to a receiving device.

Beacon transmitter 116 broadcasts a globally unique identifier which is received by computing device 140. Software or an app on computing device 140 uses the globally unique identifier to permit the computing device 140 to locate itself within some proximity of beacon transmitter 116.

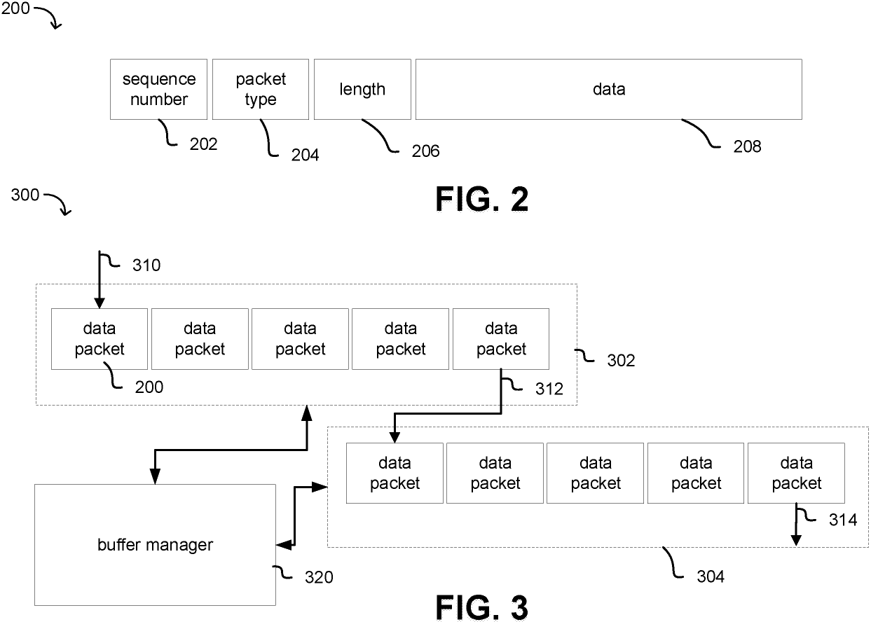

FIG. 2 shows an example of a data packet 200 encoding a bounce event. In an embodiment, event broadcasts from sensor 112 are encoded into a data packet in the form of data packet 200. Bounce events include, for example impact bounce events and depart bounce events.

Data packet 200 includes a sequence number 202. In an embodiment, sequence number increments for each data packet. Computing device 140 is able to identify a missing data packet by identifying an interruption in consecutive sequence numbers associated to received data packets.

Data packet 200 may include a packet type 204. In an embodiment packet type 204 comprises a first value signalling a variable length packet type or a second value signalling a fixed length packet type.

If data packet 200 is a variable length packet type, it includes a length 206 which indicates a number of bytes of data that follow. It also includes data 208 encoding a bounce event. If data packet 200 is a fixed length packet type, it will not include a length 206 and will instead include data 208 concatenated to sequence number 202 and packet type 204.

In an embodiment, packet type 204 is an identifier that describes an event or message that is being sent. Examples of packet types include impact bounce event, depart bounce event, battery level and sensor name. Sensor 112 and computing device 140 maintain a common list or lookup table specifying a relationship between a packet type value and a packet type. For example, a first packet type value may correspond to an impact bounce event and a second packet type value may correspond to a depart bounce event.

Data packets that represent impact bounce events, depart bounce events, or a battery level are typically fixed length. Therefore, a packet type value that corresponds to an impact bounce event, a depart bounce event, or a battery level also specifies that the data packet is a fixed length packet.

Data packets that represent a sensor name are typically variable length. Therefore, a packet type that corresponds to a sensor name also specifies that the data packet is a variable length packet.

FIG. 3 shows an example of a data array 300 suitable for storing data packets such as data packet 200 (see FIG. 2). Shown in FIG. 3 is first buffer 302 and second buffer 304. It will be appreciated that data array 300 may include more than two buffers. The use of the terms ‘first buffer’ and ‘second buffer’ is not intended to imply that data array 300 includes only two buffers.

Beacon transmitter 116 (see FIG. 1) is configured to transmit an advertisement packet over the wireless network 120. In an embodiment, the advertisement packet is limited to a maximum of 32 bytes. The advertisement packet is continually broadcast. Techniques below provide examples of how the contents of the advertisement packet can be changed.

Where an advertisement packet has a maximum size of 32 bytes, there will be approximately 23 bytes available for encoding bounce data. In an embodiment, impact and depart bounce events require 4 bytes of data. Data packets such as data packet 200 therefore require 4 bytes of data.

A maximum of 5 bounce data events may therefore be simultaneously stored in a single advertisement packet. First buffer 302 and second buffer 304 are shown as each comprising up to five data packets.

In an embodiment the data packets are maintained as a First In First Out (FIFO) queue. Data packets are added to first buffer 302 as indicated by arrow 310. Where there are already five data packets in first buffer 302, it would not be possible to add a new data packet without overflowing first buffer 302. The oldest data packet is therefore dropped from the queue as indicated by arrow 312.

In an embodiment, each of the data packets is assigned a sequence number such as sequence number 202 (see FIG. 2). When a new data packet is added to the queue that would overflow first buffer 302, the data packet with the lowest sequence number is identified as the oldest data packet. The oldest data packet is then removed from first buffer 302.

A first advertisement packet continually transmitted from beacon transmitter 116 contains the data packets maintained in first buffer 302. As data packets are added to, and removed from, first buffer 302, the contents of first advertisement packet transmitted from beacon transmitter 116 changes.

Shown in FIG. 3 is second buffer 304 configured in the same way as first buffer 302. Data packets that are removed from first buffer 302 are added to second buffer 304 as shown by arrow 312. Adding data packets to second buffer 304 may cause older data packets to be dropped from second buffer 304 as indicated by arrow 314.

In an embodiment, buffer manager 320 is implemented as a plurality of computer-executable instructions executed by at least one processor. Buffer manager 320 is configured to detect overflows in first buffer 302 and to remove data packets from first buffer 302 on detecting an overflow. Buffer manager 320 is further configured to add, to second buffer 304, data packets removed from first buffer 302.

In an embodiment, beacon transmitter 116 is configured to transmit multiple simultaneous advertisements over wireless network 120. In an embodiment, a second advertisement packet continually transmitted from beacon transmitter 116 contains the data packets maintained in second buffer 304. As data packets are added to, and removed from, second buffer 304, the contents of second advertisement packet transmitted from beacon transmitter 116 changes.

In an embodiment, an additional beacon transmitter, or a plurality of additional beacon transmitters, are each connected to wireless network 120 (see FIG. 1). In such a configuration it will be appreciated that multiple simultaneous advertisements may be transmitted from any combination of beacon transmitters rather than from single beacon transmitter 116.

Providing second buffer 304 in addition to first buffer 302 provides an additional 23 bytes of data within which to store bounce events. Multiple buffers can be used as a chain of FIFO queues for data packets to be pushed into once they drop out of the previous advertisement.

As described above, impact and depart bounce events each consume 4 bytes of data. A maximum of 5 bounce events can be simultaneously stored in a single advertisement. For average sized bounces this works out to be around 3 seconds of continuous jump activity. A bounce event is broadcast for around 3 seconds after the event has occurred before it is dropped from the advertisement.

The maximum advertisement rate permitted by the BLE protocol is 10 hz, giving approximately 30 opportunities for the computing device 140 to receive a bounce event. Adding a second buffer and second advertisement provides space for 10 bounce events which corresponds to around 7 seconds of bounce visibility. As each advertisement is still able to be broadcast at a maximum of 10 Hz there are twice as many opportunities to observe each bounce event.

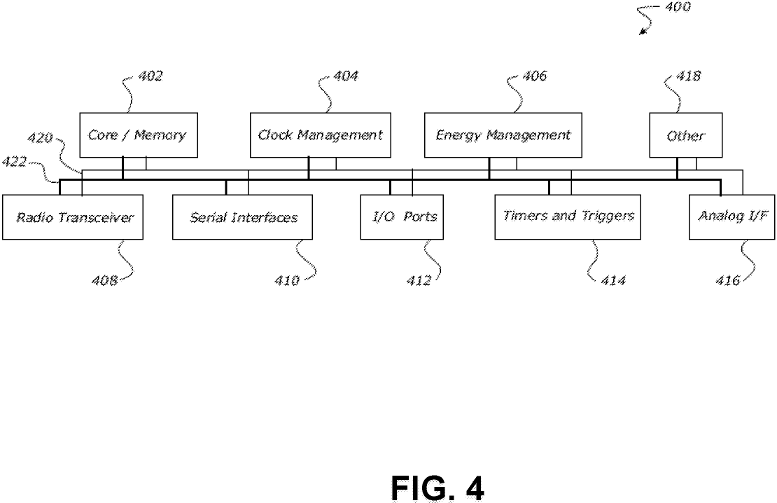

FIG. 4 shows an example of a sensor 112 from FIG. 1. In an embodiment the sensor 400 includes core/memory 402. The memory includes for example a memory protection unit, flash program memory, RAM memory, debug interface and/or DMA controller.

A clock management module 404 includes for example high frequency crystal oscillator, a low frequency crystal oscillator, low frequency RC oscillator, high frequency RC oscillator, auxiliary high frequency RC oscillator and/or ultra low frequency RC oscillator.

An energy management module 406 includes a voltage regulator, DC-DC converter, brown-out detector, voltage monitor and/or power-on reset.

In an embodiment the sensor 400 further includes radio transceiver 408, serial interfaces 410 and/or I/O ports 412. Timers and triggers 414 include timer/counter, low energy timer, pulse counter, protocol timer, watchdog timer, real time counter and calculator and/or cryotimer.

An analog I/F 416 includes ADC, Analog comparator and/or IDAC. Other modules 418 include a crypto module and/or CRC module.

At least some of the modules are connected to other modules by 32-bit bus 420 and/or Peripheral Reflex System (PRS) 422.

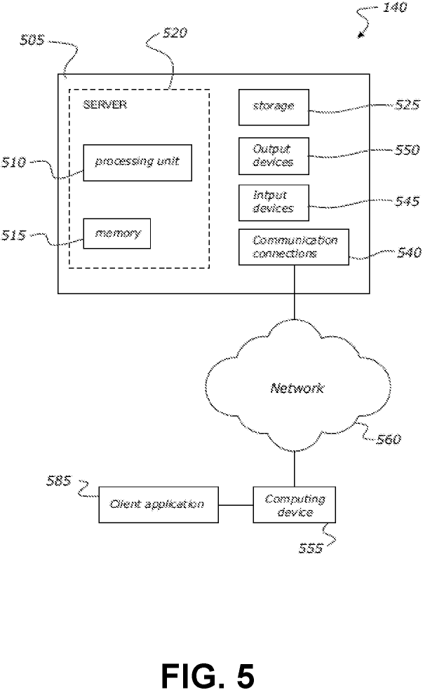

FIG. 5 is an example of a computing device 140 from FIG. 1. The computing device 140 is an example of a suitable computing device. It is not intended to suggest any limitation as to the scope of use or functionality of the operating environment.

Example computing devices include, but are not limited to, personal computers, server computers, hand-held or laptop devices, mobile devices, multiprocessor systems, consumer electronics, mini computers, mainframe computers, and distributed computing environments that include any of the above systems or devices. Examples of mobile devices include mobile phones, smartphones, tablets, and Personal Digital Assistants (PDAs).

Although not required, embodiments are described in the general context of ‘computer readable instructions’ being executed by one or more computing devices. In an embodiment, computer readable instructions are distributed via tangible computer readable media.

In an embodiment, computer readable instructions are implemented as program modules. Examples of program modules include functions, objects, Application Programming Interfaces (APIs), and data structures that perform particular tasks or implement particular abstract data types. Typically, the functionality of the computer readable instructions is combined or distributed as desired in various environments.

Shown in FIG. 5 is a computing device 140 comprising a primary computing device 505 configured to implement one or more embodiments described above. In an embodiment, computing device 505 includes at least one processing unit 510 and memory 515. Depending on the exact configuration and type of computing device, memory 515 is volatile (such as RAM, for example), non-volatile (such as ROM, flash memory, etc., for example) or some combination of the two.

A server 520 is shown by a dashed line notionally grouping processing unit 510 and memory 515 together.

In an embodiment, computing device 505 includes additional features and/or functionality. One example is removable and/or non-removable additional storage including, but not limited to, magnetic storage and optical storage. Such additional storage is illustrated in FIG. 5 as storage 525.

In an embodiment, computer readable instructions to implement one or more components provided herein are maintained in storage 525.

In an embodiment, storage 525 stores other computer readable instructions to implement an operating system and/or an application program. Computer readable instructions are loaded into memory 515 for execution by processing unit 510, for example.

Memory 515 and storage 525 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by computing device 505. Any such computer storage media may be part of device 505.

In an embodiment, computing device 505 includes at least one communication connection 540 that allows device 505 to communicate with other devices. The at least one communication connection 540 includes one or more of a modem, a Network Interface Card (NIC), an integrated network interface, a radio frequency transmitter/receiver, an infrared port, a USB connection, or other interfaces for connecting computing device 505 to other computing devices.

In an embodiment the at least one communication connection 540 includes Bluetooth L.E. components. The communication connection 540 is configured to receive bounce event timings from the sensor 112 and/or sensor 132.

In an embodiment, communication connection(s) 540 facilitate a wired connection, a wireless connection, or a combination of wired and wireless connections. Communication connection(s) 540 transmit and/or receive communication media.

Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

In an embodiment, device 505 includes at least one input device 545 such as a physical keyboard, mouse, pen, voice input device, touch input device, infrared cameras, video input devices, and/or any other input device. Device 505 also includes at least one output device 550 such as one or more displays, speakers, printers, and/or any other output device.

Input device(s) 545 and output device(s) 550 are connected to device 505 via a wired connection, wireless connection, or any combination thereof. In an embodiment, an input device or an output device from another computing device is/are used as input device(s) 545 or output device(s) 550 for computing device 505.

In an embodiment, components of computing device 505 are connected by various interconnects, such as a bus. Such interconnects include one or more of a Peripheral Component Interconnect (PCI), such as PCI Express, a Universal Serial Bus (USB), firewire (IEEE 13104), and an optical bus structure. In an embodiment, components of computing device 505 are interconnected by a network. For example, memory 515 in an embodiment comprises multiple physical memory units located in different physical locations interconnected by a network.

It will be appreciated that storage devices used to store computer readable instructions may be distributed across a network. For example, in an embodiment, a computing device 555 accessible via a network 560 stores computer readable instructions to implement one or more embodiments provided herein.

Computing device 505 accesses computing device 555 in an embodiment and downloads a part or all of the computer readable instructions for execution. Alternatively, computing device 505 downloads portions of the computer readable instructions, as needed. In an embodiment, some instructions are executed at computing device 505 and some at computing device 555.

In an embodiment, a client application 585 is provided as a thin client application configured to run within a web browser. In an embodiment the client application 585 is provided as an application on a user device. It will be appreciated that application 585 in an embodiment is associated to computing device 505 or another computing device.

The foregoing description of the invention includes preferred forms thereof. Modifications may be made thereto without departing from the scope of the invention, as defined by the accompanying claims.

1. A method of transmitting data over a wireless network comprising:
maintaining a plurality of data packets within a first buffer;
encoding at least some of the data packets within the first buffer inside a first broadcast packet;
a broadcasting device transmitting the first broadcast packet over the wireless network;
maintaining a plurality of data packets within a second buffer;
encoding at least some of the data packets within the second buffer inside a second broadcast packet;
the broadcasting device transmitting the second broadcast packet over the wireless network; and
on detecting overflow of the first buffer, removing a data packet from the first buffer and adding the removed data packet to the second buffer.

2. The method of claim 1, wherein the broadcasting device comprises a Bluetooth beacon.

3. The method of claim 2, wherein the broadcasting device comprises a Bluetooth Low Energy (BLE) beacon.

4. The method of claim 2, wherein the wireless network comprises a Bluetooth network.

5. The method of claim 1, further comprising:
encoding, within a data packet, a bounce event detected on a trampoline by a sensor; and adding the data packet to the first buffer.

6. The method of claim 5 wherein the bounce event comprises an impact bounce event or a depart bounce event.

7. The method of claim 1, further comprising maintaining the plurality of data packets within the first buffer as a First In First Out (FIFO) queue.

8. The method of claim 1, further comprising:
associating the data packets in the first buffer with respective sequence numbers; and
on detecting overflow of the first buffer, selecting for removal a data packet based at least partly on the sequence number associated to the data packet.

9. The method of claim 8 wherein selecting for removal the data packet comprises selecting for removal a data packet having the lowest sequence number when compared with other data packets maintained within the first buffer.

10. The method of claim 1, further comprising encoding each of the data packets within the first buffer inside the first broadcast packet.

11. The method of claim 1, further comprising encoding each of the data packets within the second buffer inside the second broadcast packet.

12. The method of claim 1, further comprising the broadcasting device transmitting the first broadcast packet over the wireless network to a computing device.

13. A data transmission system comprising:
a first buffer having stored therein a plurality of data packets;
a second buffer having stored therein a plurality of data packets;
a buffer manager configured to, on detecting overflow of the first buffer, remove a data packet from the first buffer and add the removed data packet to the second buffer; and
a broadcasting device configured to:
transmit at least some of the data packets within the first buffer as a first broadcast packet over the wireless network, and
transmit at least some of the data packets within the second buffer as a second broadcast packet over the wireless network.

14-16. (canceled)

17. The system of claim 13 wherein the buffer manager is configured to maintain the plurality of data packets within the first buffer as a First In First Out (FIFO) queue.

18. The system of claim 13, wherein:
the data packets in the first buffer are associated with respective sequence numbers; and
on detecting overflow of the first buffer, the buffer manager is configured to select for removal a data packet based at least partly on the sequence number associated to the data packet.

19. The system of claim 18, wherein the buffer manager is configured to select for removal the data packet by selecting for removal a data packet having the lowest sequence number when compared with other data packets maintained within the first buffer.

20. The system of claim 13, wherein the first broadcast packet includes each of the data packets within the first buffer.

21. The system of claim 13, wherein the second broadcast packet includes each of the data packets within the second buffer.

22. A computer-readable medium having stored thereon computer-executable instructions that, when executed by at least one processor, cause the at least one processor to perform a method of transmitting data over a wireless network, the method comprising:
maintaining a plurality of data packets within a first buffer;
encoding at least some of the data packets within the first buffer inside a first broadcast packet;
transmitting the first broadcast packet over the wireless network;
maintaining a plurality of data packets within a second buffer;
encoding at least some of the data packets within the second buffer inside a second broadcast packet;
transmitting the second broadcast packet over the wireless network; and
on detecting overflow of the first buffer, removing a data packet from the first buffer and adding the removed data packet to the second buffer.

23. (canceled)

24. The computer-readable medium of claim 22, the computer-executable instructions further causing the at least one processor to:
detect a bounce event on a trampoline;
encode the bounce event within a data packet; and
add the data packet to the first buffer.

25-30. (canceled)
